(19) United States
(12) Patent Application Publication
(10) Pub. No.: US 2007/0182156 A1
(43) Pub. Date: Aug. 9, 2007

(54) Self-sealing fluid fitting and method

(76) Inventor: Kip Petrykowski, Charlotte, NC (US)

Correspondence Address: STOLL KEENON OGDEN, PLLC, 2000 PNC PLAZA, 500 WEST JEFFERSON STREET, LOUISVILLE, KY, 40202, US

(21) Appl. No.: 10/657,628

(22) Filed: Sep. 8, 2003

(51) Int. Cl. F16L 41/00

(52) U.S. Cl. 285/190

(57) ABSTRACT

A fluid fitting formed in the manner of a banjo fitting includes a shank having a bore formed therethrough for receiving and passing fluid from a fluid supply and a hoop member attached to the shank and having a fluid port formed therein in fluid communication with the bore. The hoop member defines a hoop body and two opposing hoop edges. The hoop member further includes a first tapered boss defining a first sealing surface and a second tapered boss defining a second sealing surface. A bolt is provided for mounting the fitting to a fluid receiving support structure.

### BACKGROUND OF THE INVENTION

The present invention is directed broadly to mechanical fluid fittings and, more particularly, to a banjo-style fluid fitting that is self-sealing, including a method of using the fitting.

Banjo fittings are commonly used with automotive brakes and, as such, are used to direct a fluid through a 90-degree path from a brake line into a brake caliper. The typical banjo fitting will have an elongated shank with a hoop member attached thereto. The hoop member defines an open channel through which a bolt is fitted to attach the fitting to a brake caliper. Fluid flows into the fitting at a distal end of the shank and exits into a chamber defined by the bolt and hoop member and is directed into the same opening in the caliper that accommodates the attachment bolt. Generally, such bolts will be configured with one or more passageways formed there for fluid flow to the caliper. The formation of such passageways adds to the time and expense necessary to make the bolt.

Sealing banjo fittings has typically required two sealing washers with one washer fitted intermediate the bolt and the hoop member of the banjo fitting and the other washer fitted immediate the banjo fitting and the caliper. The sealing arrangement makes the banjo fitting a four-piece unit and due to the at least two disparate materials from which the main fitting body, bolt and sealing washers are constructed makes manufacturing a relatively complex process. Therefore, there exists a need for a self-sealing banjo fitting that will provide important advantages to both manufacturers and end users.

### SUMMARY OF THE INVENTION

It is accordingly an object of the present invention to provide an improved fluid fitting of the type known as a banjo fitting that provides an effective fluid seal without separate sealing washers.

It is another object of the present invention to provide such a banjo fitting that will allow the use of smaller bolts that were used with prior banjo fittings.

It is accordingly an object of the present invention to provide a self-sealing banjo fitting that will reduce the number of component parts and materials, thereby reducing manufacturing costs.

It is another object of the present invention to provide such a banjo fitting that will be adaptable to existing brake calipers with minor modification to the existing caliper structure.

To those ends, a fluid fitting includes a shank having a bore formed therethrough for receiving and passing fluid from a fluid supply; a hoop member attached to the shank and having a fluid port formed therein in fluid communication with the bore, the hoop member defining a hoop body and two opposing hoop edges, and having an axis directed through the radial center thereof. The fluid fitting further includes a first tapered boss extending outwardly from a first of the opposing hoop edges, the first tapered boss defining a first sealing surface; and a second tapered boss extending outwardly from a second of the opposing hoop edges, the second tapered boss defining a second sealing surface. Also included is a bolt for fitment through the hoop member and for threaded securement in a fluid receiving support structure, for securing the hoop member to the fluid receiving support structure and to enable fluid flow from the supply, through the fitting to the fluid receiving support structure. Preferably, said bolt is formed with a fluid channel therein for fluid communication with said hoop member and said shank member for flow therethrough to said fluid receiving support structure.

According to one preferred embodiment, the first tapered boss includes a first inner tapered wall member and a first outer tapered wall member connected to the first inner tapered wall member, with the first sealing surface being defined by the first inner tapered wall member, and wherein the bolt is formed with a bolt sealing surface complementary to the first sealing surface. It is further preferred that the present invention include a first joinder surface connecting the first inner tapered wall member and the first outer tapered wall member.

Preferably, the second tapered boss includes a second inner tapered wall member, a second outer tapered wall member connected to the second inner tapered wall member, with the second sealing surface being defined by the second outer tapered wall member. It is further preferred that the present invention include a second joinder surface connecting the second inner tapered wall member and the second outer tapered wall member.

According to another preferred embodiment, the first tapered boss includes a first inner wall member, a first outer tapered wall member and a first joinder surface connecting the first inner tapered wall member and the first outer tapered wall member, with the first sealing surface being defined by the first joinder surface and wherein the bolt is formed with a bolt sealing for sealing engagement with the first sealing surface. Preferably, the first joinder surface is formed as an edge. It is preferred that the second tapered boss includes a second inner wall member, a second outer tapered wall member connected to the second inner wall member, with the second sealing surface being defined by the second outer tapered wall member. It is further preferred that the present invention include a second joinder surface connecting the second inner wall member and the second outer tapered wall member.

One preferred embodiment of the present invention is explained in greater detail as a fluid fitting including a shank having a bore formed therethrough for receiving and passing fluid from a fluid supply; a hoop member attached to the shank and having a fluid port formed therein in fluid communication with the bore, the hoop member defining a hoop body and two opposing hoop edges, and having an axis directed through the radial center thereof. The fitting of the present invention further includes a first tapered boss extending outwardly from a first of the opposing hoop edges, including a first inner tapered wall member and a first outer tapered wall member connected to the first inner tapered wall member, with the first inner tapered wall member defining a first sealing surface. The fitting further includes a second tapered boss extending outwardly from a second of the opposing hoop edges, the second tapered boss defining a second sealing surface; and a bolt for fitment through the hoop member and for threaded securement in a fluid receiving support structure, the bolt having a bolt sealing surface formed thereon complementary to the first sealing surface formed thereon and a fluid channel formed therein for fluid communication with the hoop member and the shank member for flow therethrough to the fluid receiving support structure, thereby maintaining integrity of fluid flow from the supply, through the fitting to the fluid receiving support structure.

Preferably, the second tapered boss includes a second inner tapered wall member, a second outer tapered wall member connected to the second inner tapered wall member, with the second sealing surface being defined by the second outer tapered wall member. It is further preferred that the present invention include a second joinder surface connecting the second inner tapered wall member and the second outer tapered wall member.

According to another preferred embodiment of the present invention, a fluid fitting includes a shank having a bore formed therethrough for receiving and passing fluid from a fluid supply; and a hoop member attached to the shank and having a fluid port formed therein in fluid communication with the bore, the hoop member defining the fluid port, a hoop body and two opposing hoop edges, and having an axis directed through the radial center thereof. The present invention further includes a first tapered boss extending outwardly from a first of the opposing hoop edges, including a first inner wall member, a first outer tapered wall member and a first joinder surface connecting the first inner tapered wall member and the first outer tapered wall member, with the first sealing surface being defined by the first joinder surface. The present invention further includes a second tapered boss extending outwardly from a second of the opposing hoop edges, the second tapered boss defining a second sealing surface; and a bolt for fitment through the hoop member and for threaded securement in a fluid receiving support structure, the bolt having a bolt sealing surface complementary to the first sealing surface formed thereon and a fluid channel formed therein for fluid communication with the hoop member and the shank member for flow therethrough to the fluid receiving support structure, thereby maintaining integrity of fluid flow from the supply, through the fitting to the fluid receiving support structure. Preferably, the first joinder surface is formed as an edge.

It is preferred that the second tapered boss include a second inner wall member, a second outer tapered wall member connected to the second inner wall member, with the second sealing surface being defined by the second outer tapered wall member. Preferably, the present invention further includes a second joinder surface connecting the second inner tapered wall member and the second outer tapered wall member.

One preferred embodiment of the present invention can be described in still greater detail as a fluid fitting including a shank having a bore formed therethrough for receiving and passing fluid from a fluid supply; and a hoop member attached to the shank and having a fluid port formed therein in fluid communication with the bore, the hoop member defining the fluid port, a hoop body and two opposing hoop edges, and having an axis directed through the radial center thereof. The present invention further includes a first tapered boss extending outwardly from a first of the opposing hoop edges, including a first inner tapered wall member and a first outer tapered wall member connected to the first inner tapered wall member, the first inner tapered wall member defining a first sealing surface. Further, a second tapered boss extends outwardly from a second of the opposing hoop edges, including a second inner tapered wall member, a second outer tapered wall member connected to the second inner tapered wall member, with the second outer tapered wall member defining a second sealing surface. The present invention also includes a first joinder surface connecting the first inner tapered wall member and the first outer tapered wall member and a second joinder surface connecting the second inner tapered wall member and the second outer tapered wall member. Also included is a bolt for fitment through the hoop member and for threaded securement in a fluid receiving support structure, the bolt being formed with a bolt sealing surface complementary to the first sealing surface, and having a fluid channel formed therein for fluid communication with the hoop member and the shank member for flow therethrough to the fluid receiving support structure, thereby maintaining integrity of fluid flow from the supply, through the fitting to the fluid receiving support structure.

Another preferred embodiment of the present invention can be described in still greater detail as a fluid fitting including a shank having a bore formed therethrough for receiving and passing fluid from a fluid supply and a hoop member attached to the shank and having a fluid port formed therein in fluid communication with the bore, the hoop member defining the fluid port, a hoop body and two opposing hoop edges, and having an axis directed through the radial center thereof. The present invention further includes a first tapered boss extending outwardly from a first of the opposing hoop edges, including a first inner wall member, a first outer tapered wall member and a first joinder surface connecting the first inner tapered wall member and the first outer tapered wall member, with the first joinder surface defining a first sealing surface. The present invention also includes a second tapered boss extending outwardly from a second of the opposing hoop edges, including a second inner wall member, a second outer tapered wall member connected to the second inner wall member, with the second outer tapered wall member defining a second sealing surface. A bolt is provided for fitment through the hoop member and for threaded securement in a fluid receiving support structure, wherein the bolt is formed with a bolt sealing surface complementary to the first sealing surface with the bolt having a fluid channel formed therein for fluid communication with the hoop member and the shank member for flow therethrough to the fluid receiving support structure, thereby maintaining integrity of fluid flow from the supply, through the fitting to the fluid receiving support structure. Preferably, the first joinder surface and the second joinder surface are each formed as an edge.

The present invention is also directed to a method for directing fluid flow from a fluid supply to a threaded opening in a fluid receiving support structure. The method includes the steps of first providing a fluid fitting having a shank with a bore formed therethrough for receiving and passing fluid from the fluid supply; a hoop member attached to the shank and having a fluid port formed therein in fluid communication with the bore, the hoop member defining a hoop body and two opposing hoop edges, and having an axis directed through the radial center thereof; a first tapered boss extending outwardly from a first of the opposing hoop edges, the first tapered boss defining a first sealing surface; and a second tapered boss extending outwardly from a second of the opposing hoop edges, the second tapered boss defining a second sealing surface.

The next step is providing a bolt for fitment through the hoop member and for threaded securement in a fluid receiving support structure, to secure the hoop member to the fluid receiving support structure with the bolt including a bolt sealing surface complementary to the first sealing surface.

The method further includes the step of forming a fluid channel in one of the bolt and the fluid receiving support structure in fluid communication with the fluid port formed in the hoop member for fluid flow from the fluid supply through the fitting to the fluid receiving support structure. The steps need not be performed in order, but are all collectively required to practice the method of the present invention.

By the above, the present invention provides a fluid fitting and method that greatly improves on the present fittings, both in cost effectiveness and ease of manufacture. In addition, the present invention provides effective sealing while reducing the number of parts required to achieve fluid flow.

### BRIEF DESCRIPTION OF THE DRAWINGS

FIG. 1 is a perspective view of a self-sealing fluid fitting according to one preferred embodiment of the present invention;

FIG. 2 is a cutaway view of the self-sealing fluid fitting illustrated in FIG. 1 and taken along line 2-2 thereof;

FIG. 3 is a side view of the self-sealing fluid fitting illustrated in FIG. 1;

FIG. 4 is a top view of the fluid fitting illustrated in FIG. 1;

FIG. 5 is a bottom view of the fluid fitting illustrated in FIG. 1;

FIG. 6 is a perspective environmental view of the fluid fitting illustrated in FIG. 1;

FIG. 7 is a cutaway view of the fluid fitting illustrated in FIG. 6 generally taken along lines 6-6 thereof;

FIG. 8 is a perspective view of a self-sealing fluid fitting according to another preferred embodiment of the present invention;

FIG. 9 is a top plan view of the fluid fitting illustrated in FIG. 8; and

FIG. 10 is a side view of the fluid fitting illustrated in FIG. 8.

### DESCRIPTION OF THE PREFERRED EMBODIMENT

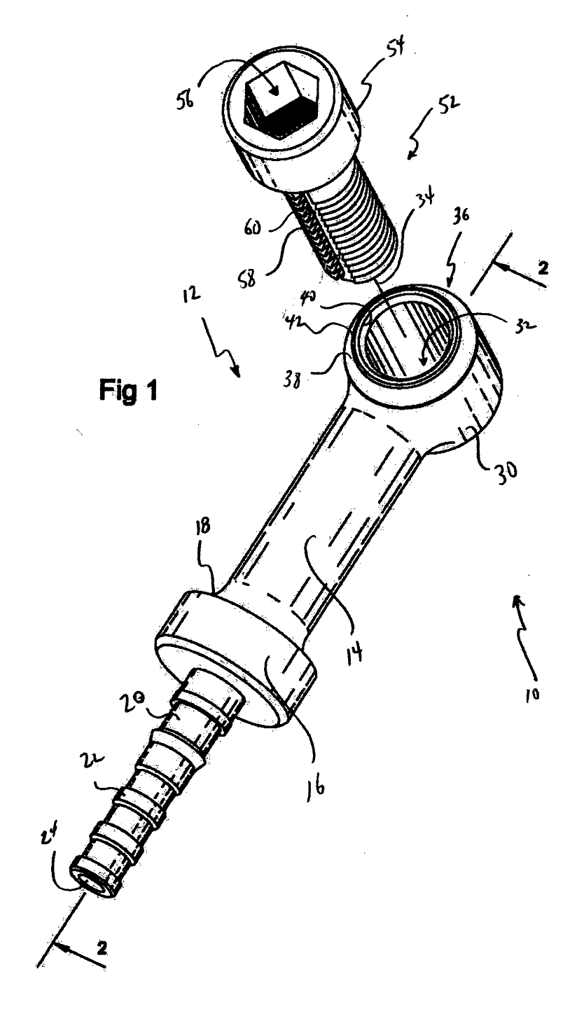

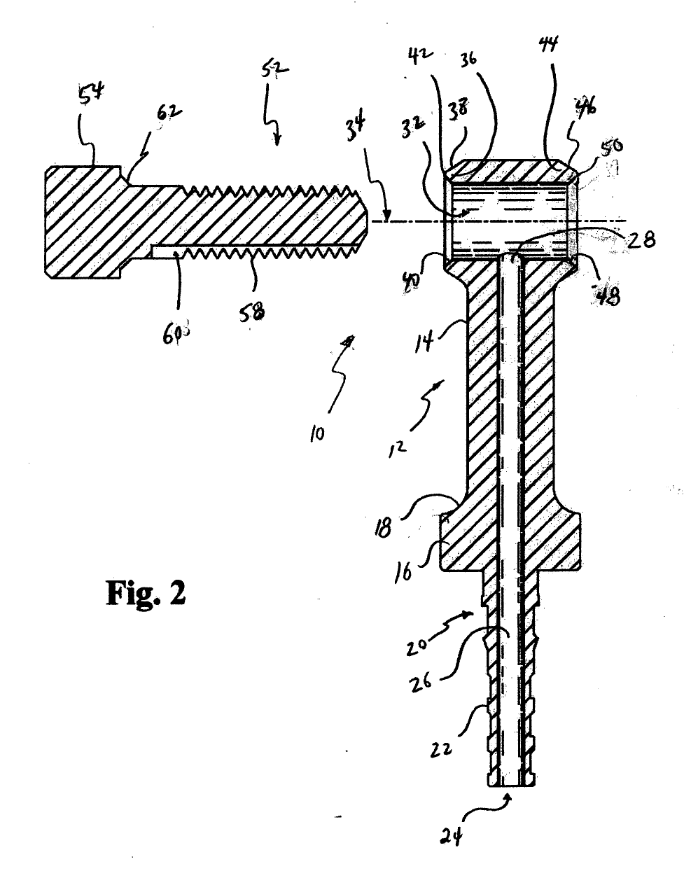

Turning now to the drawings and, more particularly, to FIGS. 1 and 2, a fluid fitting according to one preferred embodiment of the present invention is illustrated generally at 10 and includes an elongate body 12 formed with a generally cylindrical shank having a first diameter and end portion 16 having a second, greater diameter. A fillet 18 smoothes a transition area from the shank 14 to the end member 16.

An internal fluid channel 26 is formed within the body and extends form the inlet 24 to an outlet 28, as will be seen in greater detail hereinafter. A conduit connector 20, having a diameter that is less than the shank 14, projects outwardly from the end member 16. The conduit connector 20 includes a plurality of spaced ridges 22 that act as gripping members for any conduit or flexible hose attached to the conduit connector 20. An inlet opening 24 is formed in the end of the conduit connector for fluid flow into the internal fluid channel 26.

A hoop member 30 is attached to the shank 14 and defines a generally cylindrical hoop bore 32 extending therethrough, along an axis 34. The hoop bore 32 extends in a generally perpendicular manner with the longitudinal extent of the body 12. The outlet 28 directs fluid into the hoop bore 32.

This generalized structure gives rise to the name “banjo fitting,” since the structure resembles the neck and resonator of a banjo.

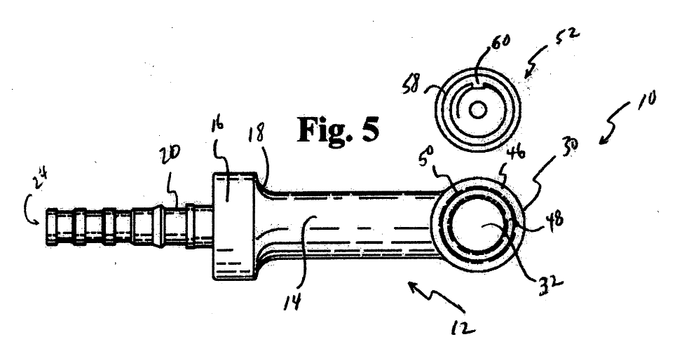

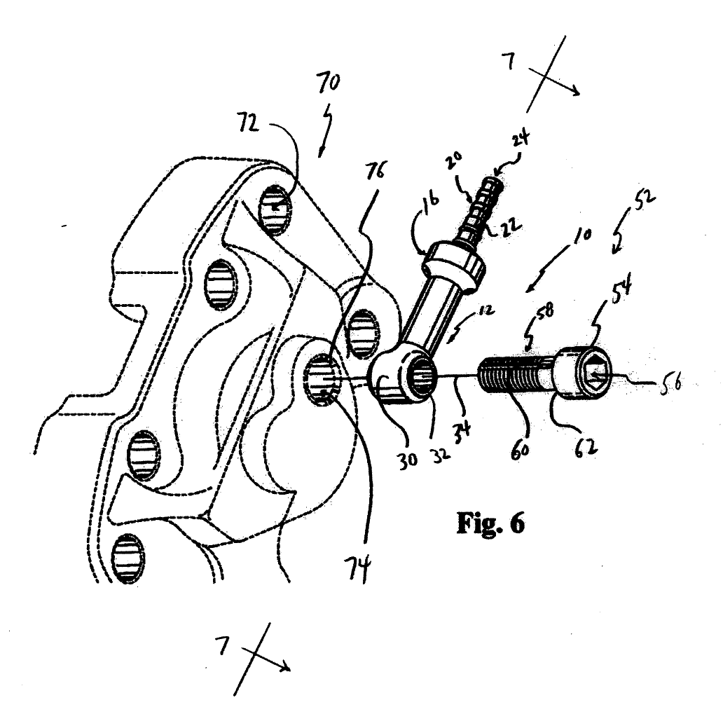

A bolt 52 is provided for maintaining the coupler in connection with its fluid receiving support structure, most commonly a brake caliper, as seen in FIGS. 5 and 6. Returning to FIG. 1, the bolt 52 includes a bolt head 54 and a threaded shank 58 projecting outwardly therefrom. The threaded shank 58 is sized to fit within the hoop bore 32. The bolt 52 illustrated herein is a hex bolt with a well 56 formed in the head defining the hex structure for receiving an Allen wrench or other hex tool. It should be noted, however, that the hex head structure should not be considered limiting to the present invention.

The bolt 52 also includes a channel 60 formed in the threaded shank and extending longitudinally therealong. The channel 60 allows fluid to flow from the body 12 and into the fluid receiving support structure as will be seen in greater detail hereinafter. The bolt 52 also includes a complementary sealing surface 62 that is formed as a tapered wall at the junction of the threaded shank 58 and the bolt head 54. Virtually any bolt of the proper size should be useful with the present invention, and the bolt 52 need not necessarily include the channel 60. The hoop member 30 may be formed with a hoop bore 32 that has a diameter that is greater than the diameter of the threaded shank 58, sufficient to support fluid flow therebetween. Under these structural circumstances, a channel, similar to the bolt channel 60, should be cut or otherwise formed in the threads of the fluid receiving support structure for flow therethrough. One of ordinary skill should be able to accomplish this without undue experimentation. Under any of these conditions, the longitudinal axis 34 should be coaxial with the bolt 52 when in use.

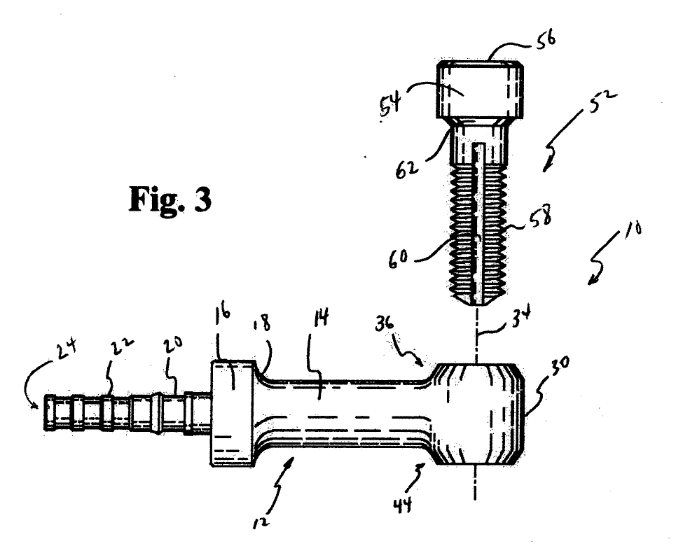

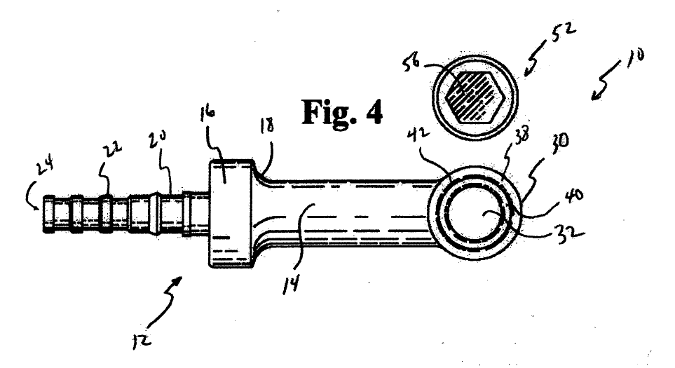

The fitting 10 also includes two opposing bosses 36, 44 that are formed on opposing ends of the hoop member as seen in FIGS. 1-5. The bosses 36, 44 include a first boss 36 for sealing contact with the bolt 52 and a second boss 44 for sealing contact with the fluid receiving support structure. The first boss 36 is formed from a first tapered outer wall 38 and a first tapered inner wall 40 that taper inwardly toward one another from the hoop member 30 as they extend outwardly therefrom. The first inner tapered wall 38 is joined at the first outer tapered wall 40 by a joinder surface 42.

According to the first embodiment of the present invention, the first inner tapered wall 40 acts as a sealing surface when the bolt member 52 is in place. In that condition, the inner tapered wall 40 abuts the bolt sealing surface 62 to form an effective fluid seal.

The second boss 44 is formed at the opposite end of the hoop member 30 from a second outer tapered wall 46 and a second inner tapered wall 48, that taper toward one another along their extent while projecting away from the hoop member 30. The second outer tapered wall 46 is joined to the second inner tapered wall 48 with a second joinder surface 50. This structure is also illustrated in FIG. 5.

By forming sealing surfaces on a hoop member 30, the common method of sealing a banjo fitting with separate washers is eliminated, and the fitting may be more easily applied and is also less costly to manufacture. Further the high pressure, small sealing contact surfaces allow the use of a smaller bolt than would normally be the case with conventional banjo fittings, thereby reducing cost over conventional fittings. The required sealing torque is also reduced.

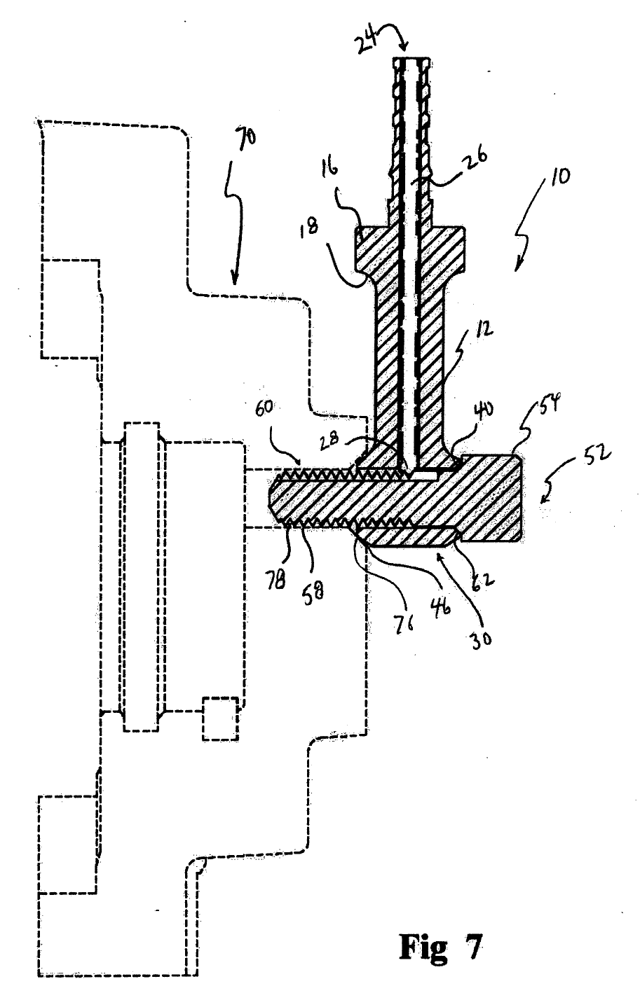

Turning now to FIG. 6, the fluid fitting 10 of the present invention is illustrated in an operational environment in an exploded view, and again in FIG. 7 in a cutaway view taken along lines 7-7 in FIG. 6. In FIG. 6, a brake caliper 70 is illustrated as an example fluid receiving support structure for the fluid fitting 10 of the present invention. It should be noted that the present invention is adaptable to all forms of use that would normally be associated with a prior banjo fitting. The caliper 70 includes a plurality of mounting holes 72 formed along the body thereof and a fluid bore 74 that acts as a mounting hole for the fitting 10 and for accepting fluid, in this case brake fluid, from a reservoir (not shown) through the fluid fitting 10 and on into the caliper 70.

In order to complete the sealing action of the present invention, the fluid bore 74 must be formed with a chamfered edge 76, which complements the boss 44 projecting from the hoop member 30. There will be apparent to those skilled in the art that, while FIG. 6 illustrates the present invention in an exploded form, the cutaway taken along lines 7-7 in FIG. 6 does not match exactly with the structure shown in FIG. 7 because the structure illustrated in FIG. 7 is not an exploded view and the parts are positioned for use. Nevertheless, the parts arrangement of the present invention should be clear from the drawings.

With respect to FIG. 7, the fluid fitting 10 is illustrated attached to the caliper 70. There, the bolt 52 is passed through the hoop member 30 into threaded engagement with the fluid bore 74 and the caliper 70 and tightened to a predetermined torque dependent upon the bolt size and other aspects of the fitment structure. The second outer tapered surface 46 abuts the sealing surface 76 formed in the caliper 70 to provide a seal at the caliper. The first inner tapered wall 40 is in abutment with the bolt sealing surface 62 to form a seal at the bolt head end of the hoop member 30. A complete fluid path is then formed from the inlet 24 through the fluid channel 26 out through the opening 28 into the hoop member 30 and down the channel 60 formed in the bolt 52 and, from there, into the caliper 70.

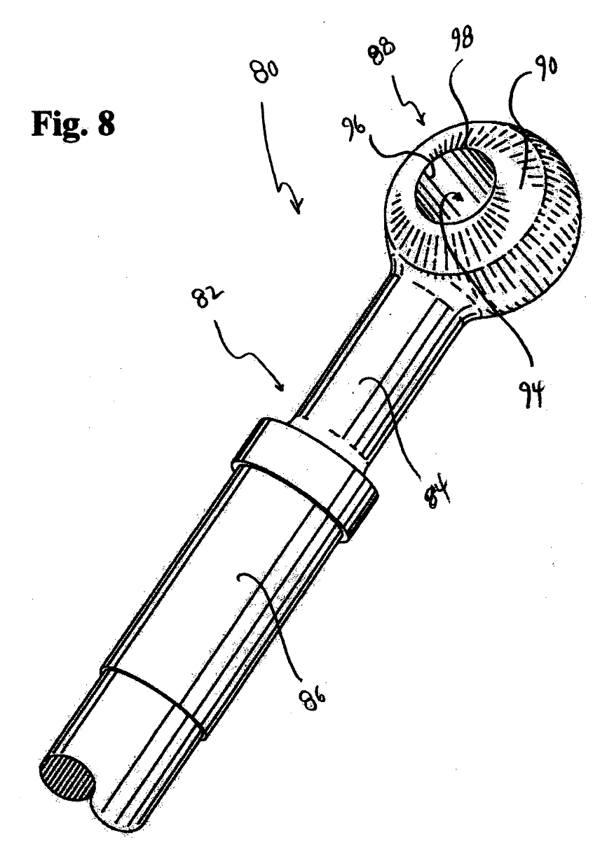

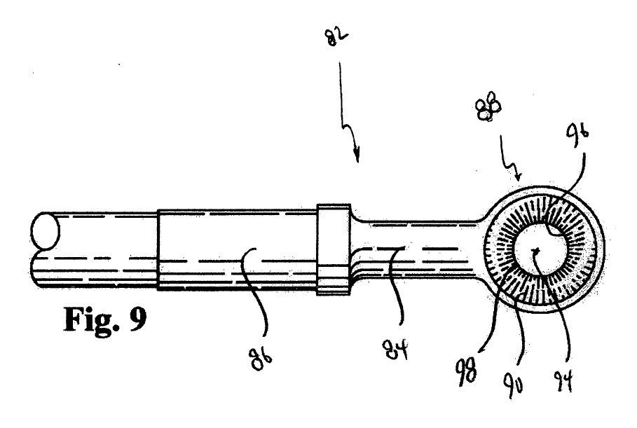

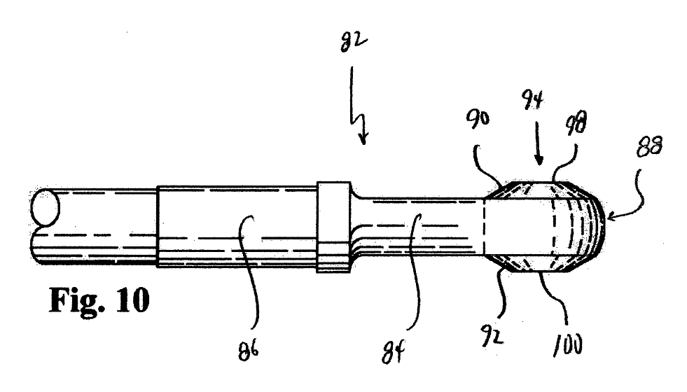

Turning now to FIG. 8, a second preferred embodiment of the present invention is illustrated and includes a body 82 formed with a generally elongate shank 84 and a generally elongate tube receiver 86 attached thereto. A hoop member 88 is disposed at the opposite portion of the shank 84 from the inlet portion 86. A first outer tapered surface 90 is formed on the hoop member to extend to an end surface 98 that is formed as a knife edge. This edge structure provides a sealing surface against the bolt and defines the internal walls 96 as sheer and cylindrical. Similar to the first embodiment, an internal fluid channel 94 extends through the hoop member 88. As seen in FIGS. 9 and 10, the structure provided in the second embodiment is symmetrical such that a second tapered wall 92 is formed on the opposing end of the hoop member 88. A lower edge 100 appears at the end of the tapered wall member 92. In use, the tapered wall 92 provides a sealing surface against a fluid receiving support structure in the manner illustrated in FIG. 7. The knife edge 98 on the opposite side of the hoop member 88 acts as a sealing surface when in abutment with a bolt.

In operation, and according to the method of the present invention, fluid may be directed form a fluid supply (not shown) through the fitting of the present invention and into the fluid receiving support structure 70. Referring to FIGS. 6 and 7, a fitting 10 is provided, including a bolt 52 and the body 12. Implied within the method of the present invention is the decision of whether to use a bolt 52 having a fluid channel 60 formed therein or to use a fully threaded bolt. Entering into the decision process is the requirement that the sealing surfaces align, no matter what embodiment of the invention is used. One result is to use a bolt with the fluid channel 60 formed therein and to closely match the diameter of the threaded shank 58 to the hoop bore 32. Fluid will then be able to flow the length of the channel from the port 28 into the caliper 70 using the mounting hole 72.

Another result would be to use a bolt with a shank diameter sufficiently smaller than the diameter of the hoop bore 32, but with a relatively large head. The relatively large head would be necessary in order to mate the bolt sealing surface 62 with the sealing surface on the hoop member 30. In this instance, the spacing between the threaded shank 58 and the hoop member 30 provides the space for fluid flow. A channel must then be formed in the threads of the mounting opening 72 to provide fluid communication between the fitting 10 and the inner caliper (not shown).

Once the type of fluid channel is chosen, the body 12 is fixed to the caliper 70 using the bolt 52. The fluid supply conduit (not shown) is connected to the receiver 20 to complete the fluid path. Fluid may then flow from the fluid supply, through the inner bore 24, out into the hoop bore 32 and, from there, into a fluid channel, and then into the caliper 70.

By the above, the present invention provides a simple improvement over a conventional banjo fitting by eliminating the need for separate sealing washers and by providing a smaller opening than would otherwise be necessary. Further, the more forgiving radiused sealing surfaces allow for misalignment and casting tolerance variations without leakage. Accordingly, the present fitting provides tangible, distinct advantages over the prior fittings.

I claim:

1. A fluid fitting comprising:
a shank having a bore formed therethrough for receiving and passing fluid from a fluid supply;
a hoop member attached to said shank and having a fluid port formed therein in fluid communication with said bore, said hoop member defining a hoop body and two opposing hoop edges, and having an axis directed through the radial center thereof;
a first tapered boss extending outwardly from a first of said opposing hoop edges, said first tapered boss defining a first sealing surface;
a second tapered boss extending outwardly from a second of said opposing hoop edges, said second tapered boss defining a second sealing surface; and
a bolt for fitment through said hoop member and for threaded securement in a fluid receiving support structure, said bolt including a bolt sealing surface complementary to said first sealing surface, said bolt being used to secure said hoop member to said fluid receiving support structure and to enable fluid flow from said supply, through said fitting to said fluid receiving support structure.

2. A fluid fitting according to claim 1 wherein said bolt is formed with a fluid channel therein for fluid communication with said hoop member and said shank member for flow therethrough to said fluid receiving support structure.

3. A fluid fitting according to claim 1 wherein said first tapered boss includes a first inner tapered wall member and a first outer tapered wall member connected to said first inner tapered wall member, with said first sealing surface being defined by said first inner tapered wall member, and wherein said bolt sealing surface is complementary to said first sealing surface for sealing engagement therewith.

3. A fluid fitting according to claim 2 and further comprising a first joinder surface connecting said first inner tapered wall member and said first outer tapered wall member.

4. A fluid fitting according to claim 1 wherein said second tapered boss includes a second inner tapered wall member, a second outer tapered wall member connected to said second inner tapered wall member, with said second sealing surface being defined by said second outer tapered wall member.

5. A fluid fitting according to claim 4 and further comprising a second joinder surface connecting said second inner tapered wall member and said second outer tapered wall member.

6. A fluid fitting according to claim 1 wherein said first tapered boss includes a first inner wall member, a first outer tapered wall member and a first joinder surface connecting said first inner tapered wall member and said first outer tapered wall member, with said first sealing surface being defined by said first joinder surface and wherein said bolt sealing surface is complementary to said first sealing surface for sealing engagement therewith.

7. A fluid fitting according to claim 6 wherein said first joinder surface is formed as an edge.

8. A fluid fitting according to claim 6 wherein said second tapered boss includes a second inner wall member, a second outer tapered wall member connected to said second inner wall member, with said second sealing surface being defined by said second outer tapered wall member.

9. A fluid fitting according to claim 8 and further comprising a second joinder surface connecting said second inner wall member and said second outer tapered wall member.

10. A fluid fitting comprising:
a shank having a bore formed therethrough for receiving and passing fluid from a fluid supply;
a hoop member attached to said shank and having a fluid port formed therein in fluid communication with said bore, said hoop member defining a hoop body and two opposing hoop edges, and having an axis directed through the radial center thereof;
a first tapered boss extending outwardly from a first of said opposing hoop edges, including a first inner tapered wall member and a first outer tapered wall member connected to said first inner tapered wall member, with said first inner tapered wall member defining a first sealing surface;
a second tapered boss extending outwardly from a second of said opposing hoop edges, said second tapered boss defining a second sealing surface; and
a bolt for fitment through said hoop member and for threaded securement in a fluid receiving support structure, said bolt having a bolt sealing surface formed thereon complementary to said first sealing surface formed thereon and a fluid channel formed therein for fluid communication with said hoop member and said shank member for flow therethrough to said fluid receiving support structure, thereby maintaining integrity of fluid flow from said supply, through said fitting to said fluid receiving support structure.

11. A fluid fitting according to claim 10 wherein said second tapered boss includes a second inner tapered wall member, a second outer tapered wall member connected to said second inner tapered wall member, with said second sealing surface being defined by said second outer tapered wall member.

12. A fluid fitting according to claim 11 and further comprising a second joinder surface connecting said second inner tapered wall member and said second outer tapered wall member.

13. A fluid fitting comprising:
a shank having a bore formed therethrough for receiving and passing fluid from a fluid supply;
a hoop member attached to said shank and having a fluid port formed therein in fluid communication with said bore, said hoop member defining said fluid port, a hoop body and two opposing hoop edges, and having an axis directed through the radial center thereof;
a first tapered boss extending outwardly from a first of said opposing hoop edges, including a first inner wall member, a first outer tapered wall member and a first joinder surface connecting said first inner tapered wall member and said first outer tapered wall member, with said first sealing surface being defined by said first joinder surface;
a second tapered boss extending outwardly from a second of said opposing hoop edges, said second tapered boss defining a second sealing surface; and
a bolt for fitment through said hoop member and for threaded securement in a fluid receiving support structure, said bolt having a bolt sealing surface complementary to said first sealing surface formed thereon and a fluid channel formed therein for fluid communication with said hoop member and said shank member for flow therethrough to said fluid receiving support structure, thereby maintaining integrity of fluid flow from said supply, through said fitting to said fluid receiving support structure.

14. A fluid fitting according to claim 13 wherein said first joinder surface is formed as an edge.

15. A fluid fitting according to claim 13 wherein said second tapered boss includes a second inner wall member, a second outer tapered wall member connected to said second inner wall member, with said second sealing surface being defined by said second outer tapered wall member.

16. A fluid fitting according to claim 15 and further comprising a second joinder surface connecting said second inner tapered wall member and said second outer tapered wall member.

17. A fluid fitting comprising:
a shank having a bore formed therethrough for receiving and passing fluid from a fluid supply;
a hoop member attached to said shank and having a fluid port formed therein in fluid communication with said bore, said hoop member defining said fluid port, a hoop body and two opposing hoop edges, and having an axis directed through the radial center thereof;
a first tapered boss extending outwardly from a first of said opposing hoop edges, including a first inner tapered wall member and a first outer tapered wall member connected to said first inner tapered wall member, said first inner tapered wall member defining a first sealing surface;
a second tapered boss extending outwardly from a second of said opposing hoop edges, including a second inner tapered wall member, a second outer tapered wall member connected to said second inner tapered wall member, with said second outer tapered wall member defining a second sealing surface;
a first joinder surface connecting said first inner tapered wall member and said first outer tapered wall member;
a second joinder surface connecting said second inner tapered wall member and said second outer tapered wall member; and
a bolt for fitment through said hoop member and for threaded securement in a fluid receiving support structure, said bolt being formed with a bolt sealing surface complementary to said first sealing surface, and having a fluid channel formed therein for fluid communication with said hoop member and said shank member for flow therethrough to said fluid receiving support structure, thereby maintaining integrity of fluid flow from said supply, through said fitting to said fluid receiving support structure.

18. A fluid fitting comprising:
a shank having a bore formed therethrough for receiving and passing fluid from a fluid supply;
a hoop member attached to said shank and having a fluid port formed therein in fluid communication with said bore, said hoop member defining said fluid port, a hoop body and two opposing hoop edges, and having an axis directed through the radial center thereof;
a first tapered boss extending outwardly from a first of said opposing hoop edges, including a first inner wall member, a first outer tapered wall member and a first joinder surface connecting said first inner tapered wall member and said first outer tapered wall member, with said first joinder surface defining a first sealing surface;
a second tapered boss extending outwardly from a second of said opposing hoop edges, including a second inner wall member, a second outer tapered wall member connected to said second inner wall member, with said second outer tapered wall member defining a second sealing surface; and
a bolt for fitment through said hoop member and for threaded securement in a fluid receiving support structure, wherein said bolt is formed with a bolt sealing surface complementary to said first sealing surface with said bolt having a fluid channel formed therein for fluid communication with said hoop member and said shank member for flow therethrough to said fluid receiving support structure, thereby maintaining integrity of fluid flow from said supply, through said fitting to said fluid receiving support structure.

19. A fluid fitting according to claim 18 wherein said first joinder surface and said second joinder surface are each formed as an edge.

20. A method for directing fluid flow from a fluid supply to a threaded opening in a fluid receiving support structure, said method comprising the steps of:
providing a fluid fitting having a shank with a bore formed therethrough for receiving and passing fluid from the fluid supply; a hoop member attached to said shank and having a fluid port formed therein in fluid communication with said bore, said hoop member defining a hoop body and two opposing hoop edges, and having an axis directed through the radial center thereof; a first tapered boss extending outwardly from a first of said opposing hoop edges, said first tapered boss defining a first sealing surface;
and a second tapered boss extending outwardly from a second of said opposing hoop edges, said second tapered boss defining a second sealing surface;
providing a bolt for fitment through said hoop member and for threaded securement in a fluid receiving support structure, to secure said hoop member to said fluid receiving support structure, said bolt including a bolt sealing surface complementary to said first sealing surface;
forming a fluid channel in one of said bolt and said fluid receiving support structure in fluid communication with said fluid port formed in said hoop member for fluid flow from said fluid supply through said fitting to said fluid receiving support structure.
